(19) United States
(12) Patent Application Publication
(10) Pub. No.: US 2009/0196973 A1
(43) Pub. Date: Aug. 6, 2009

(54) Foam Compositions

(75) Inventors: Michael Piatko, West Seneca, NY (US); Susan K. Phillips, Getzville, NY (US)

Correspondence Address: HODGSON RUSS LLP;THE GUARANTY BUILDING, 140 PEARL STREET, SUITE 100, BUFFALO, NY, 14202-4040, US

(73) Assignee: Rich Products Corporation, Buffalo, NY (US)

(21) Appl. No.: 12/363,357

(22) Filed: Jan. 30, 2009

Related U.S. Application Data
(60) Provisional application No. 61/025,510, filed on Feb. 1, 2008.

(51) Int. Cl. A23G 9/46; A23J 3/08; A23L 1/09; A23J 3/16

(52) U.S. Cl. 426/565; 426/570; 426/572; 426/569

(57) ABSTRACT

Compositions are provided for generation of edible foams. The foams can be generated using simple pump devices or other mechanical aeration devices. The compositions comprise 1-10% protein hydrolysate, 1-50% sweeteners and water. No other ingredients are required in the compositions for the generation of the foams using a simple pump dispenser.

This application claims priority to U.S. provisional application No. 61/025,510, filed on Feb. 1, 2008, the disclosure of which is incorporated herein by reference.

### FIELD OF THE INVENTION

This invention relates to the field of edible foamable compositions and in particular provides a composition which can be used in conjunction with simple pump dispenser type foaming devices or other mechanical means or systems of incorporating air into a liquid to form a foam.

### BACKGROUND OF THE INVENTION

Various foam compositions are known which need pressurized cans or gas or propellant to prepare the foam. Because these formulations need special devices such as aerosol cans to prepare the foam, they cannot be easily used.

Several foamable compositions are also known for use as landfills and to counter toxic, volatile or flammable spills. For example, U.S. Pat. No. 5,225,095 describes foamable compositions containing protein hydrolysates, metal ions, imbibing agents, water soluble polymers and co-solvents. U.S. Pat. No. 5,133,991 describes compositions containing protein hydrolysates, metal ions, and freezing point depressants. U.S. Pat. No. 6,495,056 describes foam composition containing protein hydrolysate and a foaming assistant. While such compositions are described as being useful for countering environmental hazards, most of these compositions would not be suitable for edible applications.

Further, U.S. Pat. No. 6,528,544 describes a foamable composition to counter flammable, volatile or noxious material and requires the presence of a non-hydrated thickener in water; and U.S. Patent Application Publication No. 2008/0255255 describes a composition to counter flammable material containing hydrolyzed protein and pre-gelatinized cationic modified starch. U.S. Patent Application Publication No. 2008/0014315 describes an edible foamable composition containing protein (such as dairy protein) and hydrocolloids (such as natural or synthetic gums) in specified proportions. However, the amount or type of thickeners used in these disclosures renders the compositions unsuitable for dispensing via a simple pump dispenser.

Suitable hand held pump dispersers which can be used for easy dispensing of a foam head on beverages are disclosed in U.S. Patent Application Publication No. 2006/0157512 and U.S. Patent Application Publication No. 2006/0107840. However, these publications do not provide any specific can be added on as toppings on various beverages and other food products.

### SUMMARY OF THE INVENTION

This invention provides foamable compositions for generation edible foams which can be added as a foam head or topping to beverages or other foods. The composition comprises protein hydrolysate, one or more sweeteners and aqueous medium. In one embodiment, the composition consists essentially of protein hydrolysate, sweetener(s) and aqueous medium. The composition can be used for generation of foams by using a simple pump dispenser.

In one embodiment, the composition comprises 1 -10% soy or dairy protein hydrolysate, 5-30% sugar and water. In another embodiment, the composition is free of thickening gums (such as xanthan gum and gum Arabic).

The foams can be generated using a simple pump dispenser. If filters are used in the pump (to generate a finer foam), the ingredients should be such that the filters do not get clogged. For example, thickening gums are preferably not used, but if used, should be less than 0.05% or even more preferably less than 0.02%. Further, unhydrolyzed proteins should also be avoided.

### BRIEF DESCRIPTION OF THE DRAWINGS

FIG. 1 is a graphic representation of the relationship between protein hydrolysate concentration and foam stability.

FIG. 2 is a graphic representation of the relationship between sugar concentration and foam texture.

### DETAILED DESCRIPTION OF THE INVENTION

The invention provides a composition for use in pump type dispensers for easy formation of foams. The composition comprises protein hydrolysate, one or more sweeteners and water (or an aqueous medium). Only these components are required for the formulation to be used in a pump dispenser device such as an aeration hand pump. Therefore, in one embodiment, the composition consists essentially of protein hydrolysate, one or more sweeteners and water. In another embodiment, the composition comprises protein hydrolysates, one or more sweetener and water. Optionally, additional components, such as gums, acids, salts, flavor etc. can be included to provide further stability to the foams. If used, the optional components should be added in accordance with FDA guidelines. Further, if the foam composition is to be dispensed by a pump dispenser with filters or screens, then the optional components should be such that they do not clog the dispenser. Additionally, some other ingredients present in foam compositions used for containing environmental hazards are not suitable in edible compositions and are therefore, not used in the present invention. Examples of such unsuitable ingredients are: iron salts, ammonium salts or compounds, organic solvents, fluorinated surfactants, foam boosters (such as hexylene glycol) and foam assistants (such as 2-methyl-2,4-pentanediol, 3-methyl-3-methoxy butanol, diethylene glycol monobutyl ether and diethylene glycol monoisopropyl ether).

Protein hydrolysate is a protein preparation which is prepared by subjecting proteins to enzymatic digestion with a protease enzyme or limited acid hydrolysis to achieve breakage of peptide bonds to form smaller peptides and polypeptides. The functional and biological properties of protein hydrolysates may vary depending upon factors, such as degree of hydrolysis and which protease enzyme is used for hydrolysis. Various protein hydrolysates are known in the art. For example, the following describe the manufacture of protein hydrolysates: WO0207162A1, U.S. Pat. No. 24,131,744A1, U.S. Pat. No. 23,175,407A1, U.S. Pat. No. 7,214,401, EP1327390A1 and U.S. Pat. No. 4,632,903.

For the present invention, protein hydrolysate derived from dairy, vegetable, seed or grain based proteins is used. The grain based proteins can be from soy, wheat, rice, oat, etc., and the dairy based proteins can be from milk, skim milk, whey, yogurt etc. Proteins for the preparation of the hydrolysate can also be from rice, corn, canola, flax, cottonseed and the like.

In one embodiment, the protein hydrolysate is prepared from soy protein or milk protein. The protein hydrolysate can be used in the range of 1-10% and can be 1, 2, 3, 4, 5, 6, 7, 8, 9 or 10%. In one embodiment, it is in the range of 2-6%. The protein hydrolysate is dispersed in water. A suitable example of a commercially available soy protein hydrolysate for this invention is VERSAWHIP 600 from KERRY. An example of a suitable dairy protein hydrolysate is BV50. It is preferred that the composition be free of unhydrolyzed protein as it was observed that the presence of unhydrolyzed protein can clog the pump dispenser.

The sweetener component may be a sugar sweetener or a sugar-less sweetener. Sugar sweeteners suitable for this application include mono-saccharides, di-saccharides and poly-saccharides such as sucrose (sugar), dextrose, maltose, dextrin, xylose, ribose, glucose, mannose, galactose, fructose, lactose, fructooligosaccharide syrups, trehalose, tagatose, sucromalt, corn syrup solids, such as high fructose corn syrup, honey, rice syrup, tapioca syrup, and combinations thereof. Suitable sugarless sweeteners include sugar alcohols (or polyols), such as glycerol, sorbitol, xylitol, mannitol, galactitol, maltitol, hydrogenated isomaltulose (isomalt), lactitol, erythritol, polyglycitol (e.g., syrup or powder) maltodextrins and the like. Starch (whether modified or unmodified) is not required and preferably not used in the present invention as it is likely to clog the pump dispenser. The amount of sweeteners used can be in the range of 1-50%, preferably between 5-30%. Suitable sweeteners can also include fruit juice, fruit juice concentrate or fruit concentrates. For applications where low potency sweeteners are needed (such as for salad dressings), maltose, lactose, low de corn syrup, corn syrup solids, maltodextrins, fructo-oligosaccharides, polydextrose and others can be used. The sweeteners help to provide viscosity and body to the composition.

Since only protein hydrolysate, sweetener and water is required, in one embodiment, the composition has (by weight percent) only 2-6% protein hydrolysate, 10 to 30% sweetener and water to make up to 100%.

Optionally, the composition may also contain 0.01-5% of flavors, salts (calcium, sodium or potassium), acids, alcohol, vitamins, herbal extracts color and/or preservatives (such as sorbic acid and/or calcium disodium EDTA and/or sodium benzoate).

Optionally gums can also be used. However, the gums preferably are water soluble gums such as hydroxypropyl methylcellulose (HPMC) or methylcellulose (MC). Because these gums are water soluble cellulose derivatives that are soluble at ambient temperatures, they do not have particles that can clog the filters of a pump dispenser device. However, if the concentration is too high, it can impact rheology thereby adversely affecting foam stability. Other thickening gums (such as xanthan gum, gum Arabic) can be used but if used in formulations which are to be dispensed using a pump dispenser, the thickening gum should be less than 0.1% so as not to clog the dispenser. Preferably in this embodiment, the thickening gum concentration is less than 0.05% and more preferably is between 0.01 to 0.04%. Further, if gums are used, the ratio of the protein to gum should be at least 4:1 or higher and can be as high as 8:1, 10:1, 20:1 or 100:1 (or any range therebetween) or even higher.

The formulation of the present invention can be used to form a foam head on a beverage or other foods, using a pump dispenser device such as a common hand soap pump dispenser. Such dispensers typically contain a liquid piston pump and an air pump. The liquid and the air are mixed to form a foam which is then dispensed thorough an opening (see US patent publication nos. 2006/0157512 and 2006/0107840, incorporated herein by reference). Upstream of the dispensing opening, the device can have a screen which selects the size of any particular matter. The screens sizes can be 100 to 150 mesh (98 to 149 microns pore size) for the first filter and if a second filter is present, 200-255 mesh (55-75 microns pore size) for the second filter. By using one or more filters, a finer foam can be obtained. The formulations of the present invention can also be prepared into foams by hand or by using a hand or electric mixer, continuous mixing systems like the CR mixers form Cherry-Burrell and other manufacturers or any other mechanical device that incorporates air into liquid but preferably does not need to be pressurized.

Foams prepared from the compositions of the present invention were found to be stable as judged by the air cell structure which includes the air cell size and foam volume. Foams created by using the compositions of the present invention in a pump dispenser are preferably stable for at least 5 minutes on a beverage, preferably a warm beverage (such as at 75° F.) or hot beverage (such as at 180° F.). More preferably, it is stable for 10, 15, 20, 25, 30, 40, 50 or 60 minutes at 75° F. In still other embodiments it is stable for at least 2 minutes at 180° F. At lower than 75° F. temperatures, the foam structure can be maintained for several hours and for several weeks if frozen. The density of the foams formed from the present formulations is between 0. 1 to 0.3 g/ml and preferably between 0. 1 to 0.2 or 0. 1 to 0. 18 g/ml. Above a density of 0.3 the foam structure becomes very soft and runny and is comprised of large and unstable air cells. Preferably the foam is dry foam with small air cell size approximately less than 100 microns but air cell size of up to 1000 microns is also acceptable. Typically, small air cells (or bubbles) are considered to be those that are less than 100 microns in diameter, medium air cells are 100 microns or more but less than 1000 microns, and large air cells are greater than 1000 microns.

Foams formed by the composition of the present invention can be used as foam heads or foam toppings to garnish hot or cold beverages, desserts, salads, soups, meats, bakery items, breakfast, lunch or dinner entrees (if using savory flavor system) and/or as a dessert or appetizer itself if frozen or stabilized with hydrocolloids. Foams formed by the composition of the present invention can be used to provide nutritional, herbal and or healthful benefits to the products they are topping. It should be noted that the foams formed by the present compositions and methods are exogenous foams; i.e., they are not formed by the mixing of air with the beverage or the food product itself, but rather are created external to the beverage (or the portion of the beverage on which the foam is desired) or the food product and simply added as a topping to the beverage or the food product. A portion of the beverage may be used in generation of the foam which can then be directly dispensed on another portion of the same beverage or another beverage. The foam can be directly dispensed on the food item or can be transferred to a bag or some other container from which it can be dispensed on to the food item. The foam after being transferred to a bag or container can be stored in the freezer or refrigerator for subsequent dispensing on the food item.

In one embodiment, instead of water, or in addition to water, fruit juices can also be included. The pH of the composition can be between 2 and 5, preferably between 2 and 4.5 or between 2 and 4 to prolong shelf stability. Foams formed by these compositions can be used on fruit drinks and other beverages or food items where fruit flavor or fruit foam is desirable. Examples of juices include apple juice, grape juice, pear juice, nectarine juice, currant juice, raspberry juice, blueberry juice, strawberry juice, pomegranate juice, guava juice, kiwi juice, mango juice, papaya juice, watermelon juice, cantaloupe juice, cherry juice, cranberry juice, peach juice, apricot juice, plum juice, and pineapple juice; citrus juices such as orange juice, lemon juice, lime juice, grapefruit juice, and tangerine juice; and vegetable juice such as carrot juice and tomato juice and the like; and combinations thereof.

In another embodiment, instead of water, or in addition to water, any drinkable liquid including tea, coffee, carbonated or non-carbonated drinks or alcoholic drinks can be used.

The composition may also contain natural flavors, artificial flavors, spices, seasonings, and the like. The natural flavors include balsamic vinegar, apple cider vinegar, other fruit or vegetable flavors, vanilla flavor, tea or coffee flavors, cocoa flavor, chocolate flavor, mint flavors, and the like. The composition may also contain natural or artificial colors.

In another embodiment, a vitamin and/or herbal extract can be added to the formulation without significantly affecting the foaming ability of the composition. The addition of a vitamin and/or herbal extract will enhance the health benefit of the compositions, e.g. vitamin C can be added to this formula at 1.0% to provide a 50% RDA for each serving (approx 3 ml). A pH range of 2 to 4.5 is preferable for enhancing the shelf storage ability of vitamin C but other means of preservation, e.g. freezing would allow for pH in the range 4.5 to 10 which may be useful for other vitamins and/or herbal extracts.

In another embodiment, a preservative can be added to the formulation without significantly affecting the foaming ability of the composition. The addition of preservative should enhance the shelf storage of the compositions. For example, acetic acid can be used. This preservative effectively lowers the pH and provides antimicrobial activity as well. Other acids such as citric acid, lactic, malic and the like can also be used to lower pH and provide ambient shelf-life as well. A pH range of 2 to 4.5 is preferable for enhancing the shelf storage ability. The composition of the present invention can also be stored frozen and upon removal from the freezer, can be thawed at ambient temperature and used.

The following examples are presented to further describe the invention. These examples are intended to be illustrative and not limiting.

### EXAMPLE 1

This example describes the various combinations of the soy protein hydrolysate (Versawhip 600) and sugar. The composition is shown in Table 1

TABLE 1

| | | | | FOAM | | |
|---|---|---|---|---|---|---|
| | | | FOAM | STABILITY | FOAM | |
| | | | DENSITY | (MIN starting | TEXTURE | |
| WATER | Soy Hydrolysate | SUGAR | (g/ml) | @ 180 F.) | SCORE | AW |
| 71 | 4 | 25 | 0.1567 | 18 | 1 | 0.971 |
| 53 | 2 | 45 | 0.202 | 18 | 2 | 0.937 |
| 51 | 4 | 45 | 0.178 | 25 | 3 | 0.939 |
| 68 | 2 | 30 | 0.153 | 8 | 1 | 0.967 |
| 64 | 6 | 30 | 0.1583 | 34 | 1 | 0.965 |
| 49 | 6 | 45 | 0.1667 | 30 | 4 | 0.93 |
| 73 | 2 | 25 | 0.152 | 9 | 1 | 0.98 |
| 66 | 4 | 30 | 0.155 | 32 | 1 | 0.96 |
| 69 | 6 | 25 | 0.16 | 34 | 1 | 0.972 |

1. firm, dry foam, small air bubbles
2. moderate firmness with small air cell structure and few medium sized bubbles
3. soft foam with some medium bubbles
4. soft foam with large air bubbles
5. very soft, wet foam, rapidly collapsing into large air bubbles

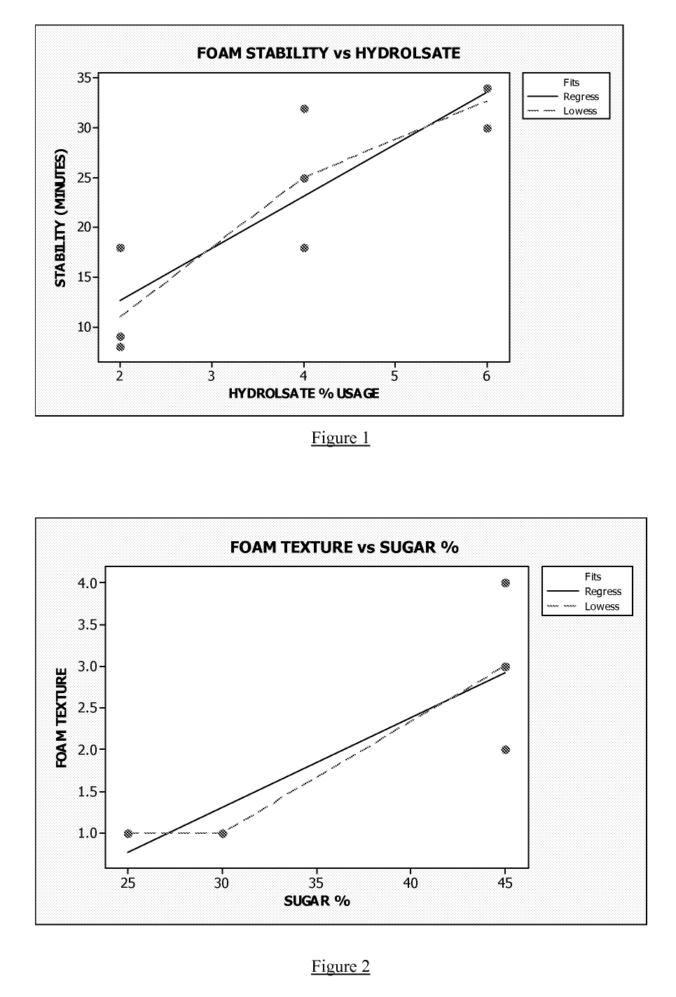

The data obtained from the above experiments is shown in FIGS. 1-3. FIG. 1 shows the effect of hydrolysate level on foam stability. A positive impact on stability with increased levels of hydrolysate can be seen from 2 to 6%. The performance was not observed to significantly increase at higher than 6% hydrolysate. However, an adverse effect on taste is noticed at higher than 6% and the impact on taste (strong bitterness) limits hydrolysate usage to 10%. FIGS. 2 shows the negative effect of sweetener level on foam texture (graded as indicated in Table 1) limiting the level of sweetener to 50%. This data shows that performance is compromised as sugar concentration increases.

### EXAMPLE 2

This example describes the various compositions of the present invention. The data shows that the effect of dairy protein, xanthan gum, hydroxyl-propyl-methyl cellulose in a hand pump foaming system. The hand pump roamer system is easily clogged if the particle size of the dispersion is too large. Levels of 1% sodium caseinate or 0.2% xanthan were found to quickly clog the roamer. Data is shown in Table 2. Compositions 1, 3, 5, 6 and 7 were usable with a pump dispenser while Compositions 2 and 4 were not usable with the pump dispenser. Composition 7 was not usable on hot beverages but can be used for non-beverage use—such as for salad dressings.

TABLE 2

| | wt % | GRAMS | |
|---|---|---|---|
| Composition 1 | | | |
| BV 50 (CASEIN HYDROLSTATE) | 2 | 10 | FOAM ACCEPTABLE |
| WATER | 73 | 365 | STABLE FOR 60 |
| SUGAR | 25 | 125 | MINUTES AT 75 F. |
| TOTAL | 100 | 500 | DISPERSED WITHIN |
| DISPERSE IN HOT WATER ADD SUGAR AND | | | 2 MINUTES ON 180 F. |
| HEAT TO 75 C., COOL TO 5 C. | | | WATER |
| Composition 2 | | | |
| BV 50 | 2 | 10 | CLOGGED SYSTEM |
| XANTHAN GUM | 0.2 | 1 | NOT ABLE TO FOAM |
| WATER | 72.8 | 364 | |
| SUGAR | 25 | 125 | |
| TOTAL | 100 | 500 | |
| DISPERSE IN HOT WATER ADD SUGAR AND | | | |
| HEAT TO 75 C., COOL TO 5 C. | | | |
| Composition 3 | | | |
| BV 50 | 2 | 10 | FOAM ACCEPTABLE |
| F50 (hydroxyproplymethylcellulose) | 0.1 | 0.5 | BUT COARSER |
| WATER | 72.9 | 364.5 | THAN BV50 ALONE |
| SUGAR | 25 | 125 | STABLE FOR 60 |
| TOTAL | 100 | 500 | MINUTES AT 75 F. |
| DISPERSE IN HOT WATER ADD SUGAR AND | | | DISPERSED WITHIN |
| HEAT TO 75 C., COOL TO 5 C. | | | 2 MINUTES ON 180 F. |
| | | | WATER |
| Composition 4 | | | |
| BV 50 | 2 | 10 | CLOGGED SYSTEM |
| SODIUM CASEINATE | 1 | 5 | NOT ABLE TO FOAM |
| WATER | 72 | 360 | |
| SUGAR | 25 | 125 | |
| TOTAL | 100 | 500 | |
| DISPERSE IN HOT WATER ADD SUGAR AND | | | |
| HEAT TO 75 C., COOL TO 5 C. | | | |
| Composition 5 | | | |
| VERSAWHIP 600 (SOY HYDROLSTATE) | 2 | 10 | FOAM ACCEPTABLE |
| XANTHAN GUM | 0.02 | 1 | STABLE FOR 60 M at |
| WATER | 72.98 | 364 | 75 F. |
| SUGAR | 25 | 125 | DISPERSED WITHIN |
| TOTAL | 100 | 500 | 10 MINUTES ON 180 F. |
| DISPERSE IN HOT WATER ADD SUGAR AND | | | WATER |
| HEAT TO 75 C., COOL TO 5 C. | | | |
| Composition 6 | | | |
| VERSAWHIP 600 (SOY HYDROLSTATE) | 2 | 10 | FOAM ACCEPTABLE |
| XANTHAN GUM | 0.04 | 1 | STABLE FOR 60 |
| WATER | 72.96 | 364 | MINUTES AT 75 F. |
| SUGAR | 25 | 125 | DISPERSED WITHIN |
| TOTAL | 100 | 500 | 10 MINUTES ON 180 F. |
| DISPERSE IN HOT WATER ADD SUGAR AND | | | WATER |
| HEAT TO 75 C., COOL TO 5 C. | | | |
| Composition 7 | | | |
| VERSAWHIP 600 (SOY HYDROLSTATE) | 2 | 10 | FOAM SOFT AND |
| XANTHAN GUM | 0.08 | 1 | LOOSE. |
| WATER | 72.92 | 364 | STABLE FOR 60 |
| SUGAR | 25 | 125 | MINUTES AT 75 F. |
| TOTAL | 100 | 500 | DISPERSED WITHIN |
| DISPERSE IN HOT WATER ADD SUGAR AND | | | 2 MINUTES ON 180 F. |
| HEAT TO 75 C., COOL TO 5 C. | | | WATER |

### EXAMPLE 3

The following data (Table 3) shows a comparison of different hydrolysates. In Examples 3-4, Versawhip and HydroFoama were purchased from Kerry Foods and BV50 was purchased from DMV Ingredients. HydroFoama is a casein hydrolysate and BV50 is casein hydrolysate from DMV Ingredients. Versawhip is a soy protein hydrolysate. The data shows the range of performance for various types of hydrolysates.

TABLE 3

| | | | | | Foam | | | |
|---|---|---|---|---|---|---|---|---|
| | | | | Foam | Stability | Foam | | AW |
| | Water | Hydrolysate | Sugar | Density | (Min @ | Texture | | (water |
| Hydrolysate | (wt %) | (wt %) | (wt %) | (g/ml) | 180 F.) | Score | pH | activity) |
| None | 75 | 0 | 25 | 1 | 0 | * | 4.93 | 0.973 |
| BV50 | 73 | 2 | 25 | 0.16 | 1 | 3 | 8.48 | 0.977 |
| Versawhip | 73 | 2 | 25 | 0.16 | 40 | 1 | 5.45 | 0.97 |
| 600 | | | | | | | | |
| Hyfoama | 73 | 2 | 25 | 0.12 | 4 | 3 | 8.54 | 0.958 |
| DSN K | | | | | | | | |
| Hyfoama | 73 | 2 | 25 | 0.17 | 5 | 3 | 4.74 | 0.968 |
| 78K | | | | | | | | |

* Did not foam
1. firm, dry foam, small air bubbles
2. moderate firmness with small air cell structure and few medium sized bubbles
3. soft foam with some medium bubbles
4. soft foam with large air bubbles
5. very soft, wet foam, rapidly collapsing into large air bubbles

These scores were assigned by visual inspection.

### EXAMPLE 4

This example describes the use of fruit juice instead of water. By using such formulations, the present compositions can be used as foam toppings for fruit drinks. Data is shown in Table 4.

TABLE 4

| | | | | | Foam | | | |
|---|---|---|---|---|---|---|---|---|
| | | | | Foam | Stability | Foam | | |
| | Juice | Hydrolsate | Sugar | Density | (Min @ | Texture | | |
| Hydrolsate | (wt %) | (wt %) | (wt %) | (g/ml) | 180 F.) | Score | pH | AW |
| Versawhip 600 | 75 | 2 | 25 | 0.12 | 60 | 2 | 3.33 | 0.917 |
| Versawhip 600 | 71 | 4 | 25 | 0.09 | 60 | 2 | 3.76 | 0.922 |
| Versawhip 600 | 69 | 6 | 25 | 0.085 | 60 | 1 | 3.95 | 0.893 |

### EXAMPLE 5

This following provides examples of foam preparation for salads. Two formulations are presented—one for wine containing salad dressing and the other for balsamic salad dressing.

TABLE 5A
Red Wine Salad Dressing

| | wt % |
|---|---|
| Water | 75.725% |
| Red wine vinegar | 5.00% |
| Wine | 5.00% |
| Vinegar | 5.00% |
| Sugar | 3.00% |
| Corn syrup | 3.00% |
| Hydrolyzed soy protein | 2.00% |
| Salt | 0.50% |
| Flavors | 0.50% |
| Xanthan gum | 0.025% |
| preservatives | 0.25% |
| TOTAL | 100.00% |
| pH | 2.6 |

TABLE 5B
Balsamic Salad Dressing

| | wt % |
|---|---|
| Water | 75.73% |
| balsamic vinegar | 15.00% |
| Sugar | 3.00% |
| corn syrup | 3.00% |
| Hydrolyzed soy protein | 2.00% |
| Salt | 0.50% |
| Flavors | 0.50% |
| Xanthan gum | 0.02% |
| preservatives | 0.25% |
| TOTAL | 100.00% |
| pH | 2.77 |

### EXAMPLE 6

The following preparation can be dispensed from a simple manual pump dispenser or prepared in mechanical aeration system then used to top smoothies, carbonated sodas, breakfast entrees, etc. or frozen after being dispensed and served as dessert of aperitif providing a fruit based treat containing a significant RDA of vitamin C (Table 6).

TABLE 6
Cherry Vitamin C Fortified Frozen Apertif

| | wt % |
|---|---|
| Filtered Cherry Juice | 76.25% |
| Sugar | 15.00% |
| corn syrup | 3.00% |
| Hydrolyzed soy protein | 4.00% |
| Cherry flavor | 0.50% |
| Ascorbic Acid | 1.00% |
| preservatives | 0.25% |
| | 100.00% |

While this invention has been illustrated by providing certain specific examples, these examples are not intended to be restrictive and routine changes to these formulations based on the disclosure in this application can be made by those skilled in the art. Such changes are intended to be within the scope of the present invention.

We claim:

1 An edible foaming composition comprising from 1-10% protein hydrolysate, 1-50% sweetener and aqueous medium.

2. The composition of claim 1, wherein the composition is free of modified starch, unhydrolyzed protein and iron salts.

3. The composition of claim 1, wherein the protein hydrolysate is used at a concentration of 2-6%.

4. The composition of claim 1, wherein the protein hydrolysate is dairy protein hydrolysate.

5. The composition of claim 4, wherein the dairy protein is from milk or whey.

6. The composition of claim 1, wherein the protein hydrolysate is vegetable, seed or grain protein hydrolysate.

7. The composition of claim 6, wherein the protein hydrolysate is soy protein hydrolysate.

8. The composition of claim 1, wherein the sweetener is between 10 and 30%.

9. The composition of claim 2, further comprising flavoring agents.

10. The composition of claim 1, wherein the aqueous medium is water.

11. The composition of claim 1, wherein the aqueous medium is juice, coffee or tea.

12. An edible foaming composition consisting essentially of from 1-10% protein hydrolysate, 1-50% sweetener and aqueous medium.

13. The composition of claim 12, wherein the protein hydrolysate is prepared from dairy, vegetable, seed or grain protein and is present from 2-6% and the sweetener is from 20 to 30%.

14. The composition of claim 13, wherein the hydrolysate is prepared from soy protein or dairy protein.

15. A method for forming an exogenous foam head on a beverage comprising the steps of:
a) providing a composition of claim 1;
b) generating a foam from the composition of a) by introducing air into the composition;
c) dispensing the foam on a food item.

16. The method of claim 15, wherein the food item is selected from the group consisting of beverage, soup, salad and dessert.

17. The method of claim 15, wherein the foam in step b) is generated by a pump dispenser.

18. The method of claim 15, wherein the foam is generated by using a device selected from the group consisting of hand mixer, electric mixer or a continuous mixer.

19. The method of claim 15, wherein the foam generated in b) is frozen and thawed and then dispensed in step c).

20. The method of claim 15, wherein the foam from step b) is transferred to a bag or container from which it can be dispensed on a food item in step c).
